(19) United States
(12) Patent Application Publication
(10) Pub. No.: US 2004/0075777 A1
(43) Pub. Date: Apr. 22, 2004

(54) Function control apparatus using remote control and method of controlling the same

(75) Inventor: Kang-heuy Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/646,869

(22) Filed: Aug. 25, 2003

(30) Foreign Application Priority Data
Oct. 4, 2002 (KR) 2002-60527

(51) Int. Cl. H04N 5/44

(52) U.S. Cl. 348/734; 340/825.72; 345/169

(57) ABSTRACT

A function control apparatus, which controls the functions of an image processing apparatus using a remote control, includes a remote control signal receiver receiving a remote control signal output from the remote control; a memory unit storing major function information and additional function information of the image processing apparatus; a controller causing the additional function information stored in the memory unit to be displayed and causing an additional function that is selected based on the displayed additional function information to be performed, in response to the remote control signal containing a request to display the additional function information; and a display unit displaying the additional function information controlled by the controller. The additional function information is displayed as on-screen-display (OSD) data.

### CROSS-REFERENCE TO RELATED APPLICATIONS

This application claims the priority of Korean Patent Application No. 2002-60527, filed Oct. 4, 2002, in the Korean Intellectual Property Office, the disclosure of which is incorporated herein in its entirety by reference.

### BACKGROUND OF THE INVENTION

1. Field of the Invention

The present invention relates to a function control apparatus using a remote control and a method of controlling the same, and, more particularly, to a function control apparatus using a remote control with a minimum number of buttons, and a method of controlling the same.

2. Description of the Related Art

An increase in the numbers and functions of electric goods, which are controlled by remote controls, results in an increase in the functions of remote controls. Also, an increase in the functions of the remote control results in an increase in the number of buttons on the remote control. If the number of buttons increases, a reduction in the size of each button or an increase in the size of the remote control is unavoidable. As a result, users may feel some inconveniences when using a remote control. For instance, the user may need to take extra time to find a desired function button on a remote control, or have difficulty in controlling the function button even if it can be easily found.

In particular, an integrated remote control includes function buttons for controlling all functions of electric goods. Therefore, the integrated remote control may include a short function button in which the functions of a plurality of function buttons are integrated. A user may feel inconvenienced when handling such an integrated remote control, and may have to learn how to handle such an integrated remote control over an extended period of time.

### SUMMARY OF THE INVENTION

The present invention provides a function control apparatus using a remote control with a minimum number of buttons and a method of controlling the same.

The present invention also provides a function control apparatus using a remote control in which major function buttons and additional function buttons separately are operated based on the frequency of uses, and a method of controlling the same.

Additional aspects and/or advantages of the invention will be set forth in part in the description which follows and, in part, will be obvious from the description, or may be learned by practice of the invention.

According to an aspect of the present invention, there is provided an apparatus for controlling the functions of an image processing apparatus using a remote control, the apparatus comprising: a remote control signal receiver receiving a remote control signal output from the remote control; a memory unit storing major function information and additional function information of the image processing apparatus; a controller causing the additional function information stored in the memory unit to be displayed and causing an additional function that is selected based on the displayed additional function information to be performed, in response to the remote control signal containing a request to display the additional function information; and a display unit displaying the additional function information controlled by the controller.

In another aspect of the present invention, the apparatus may further include an on-screen-display (OSD) processor controlled by the controller, generating OSD data corresponding to the additional function information, and outputting the OSD data to the display unit.

Also, another aspect of the present invention may provide that in response to the controller receiving a selection signal corresponding to desired additional function information, the controller marks the desired additional function information selected among the displayed additional function information. Also, the major function information and the additional function information stored in the memory unit may be categorized by the frequency of use of the information.

According to another aspect of the present invention, there is provided a method of controlling the functions of an image processing apparatus using a remote control, the method comprising: parsing a received remote control signal received from the remote control; displaying information for available additional functions on the image processing apparatus if the remote control signal contains a request for displaying information of additional functions; and performing a function of the image processing apparatus which corresponds to a selection signal in response to the selection signal being received from the remote control while the additional function information is displayed.

In another aspect of the present invention, the additional function information may be displayed as OSD data.

Also, in response to receiving position information for selecting desired additional function information among the additional function information displayed, a position for the selected additional function information may be marked on the displayed additional function information so that a user can perceive the selected additional function information.

Also, the additional function information may be determined based on the frequency of use of information in the image processing apparatus.

### BRIEF DESCRIPTION OF THE DRAWINGS

These and other aspects and/or advantages of the invention will become apparent and more readily appreciated from the following description of the preferred embodiments, taken in conjunction with the accompanying drawings of which:

FIG. 1 is a block diagram of an example of a system to which a function control apparatus using a remote control, according to an embodiment of the present invention, is applied;

FIG. 2A illustrates an example of the button structure of a remote control according to an embodiment of the present invention;

FIG. 2B illustrates a display screen on which information regarding additional functions of a remote control, according to an embodiment of the present invention, is displayed; and

FIG. 3 is a flowchart illustrating a method of controlling functions of a system using a remote control according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

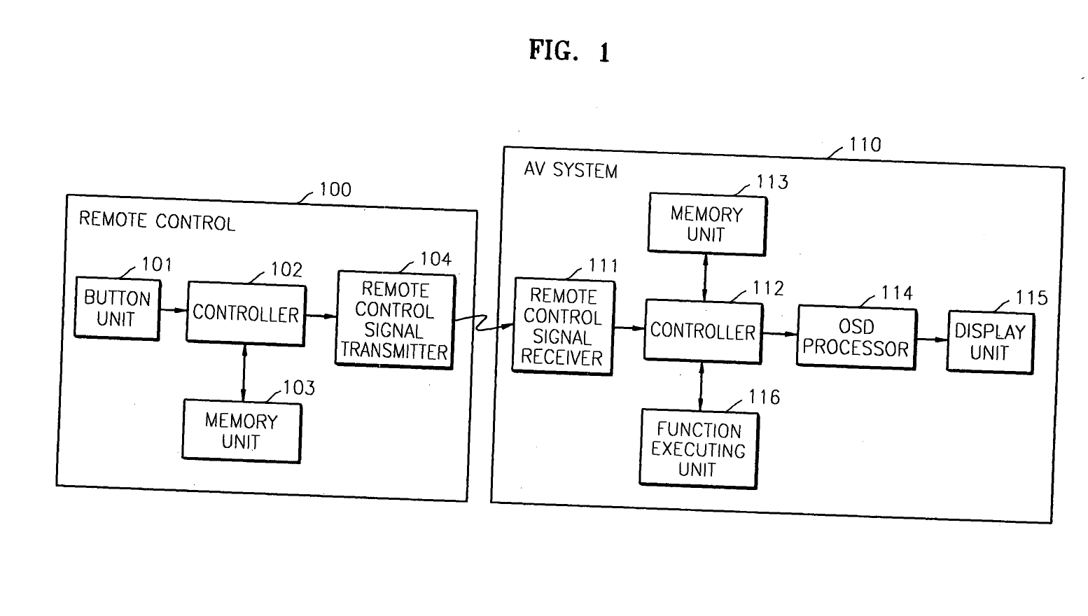

FIG. 1 is a function block diagram of a system to which a function control apparatus using a remote control, according to a preferred embodiment of the present invention, is applied. Referring to FIG. 1, the system includes a remote control 100 and an audio/video (AV) system 110.

The remote control 100 controls the operation of the AV system 110. The remote control 100 includes a button unit 101, a controller 102, a memory unit 103, and a remote control signal transmitter 104.

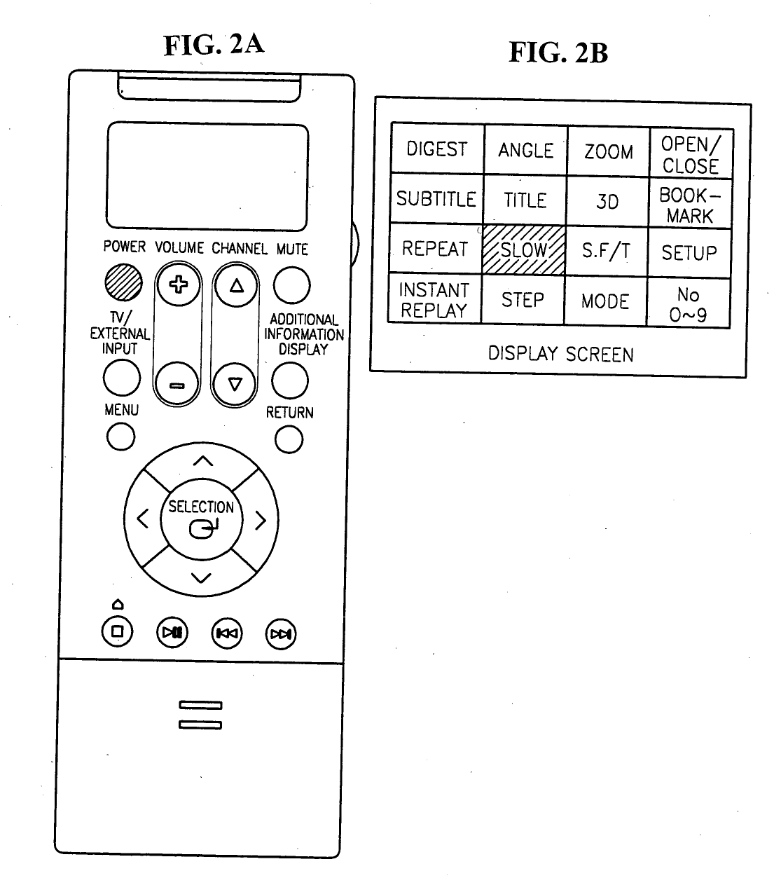

As shown in FIG. 2A, the button unit 101 includes a plurality of major function buttons and an additional function display button. FIG. 2A illustrates an example of the button structure of a remote control according to a preferred embodiment of the present invention. The types of major function buttons depend on the functions of the AV system 110.

The plurality of major function buttons are used to control functions of the AV system 110 which are frequently used. Additional functions are functions of the AV system 110 that are not controlled by the plurality of major function buttons, because they are usually not as frequently used as the major functions which are controlled using the plurality of the major function buttons. The additional function display button is a button for requesting a display of the additional functions. The additional functions include functions that are newly added to the AV system 110.

The controller 102 controls the remote control signal transmitter 104, causing it to transmit a remote control signal to the AV system 110 when a user presses a certain button included in the button unit 101. To transmit the remote control signal, the controller 102 refers to code information stored in the memory unit 103. The code information corresponding to buttons included in the button unit 101 is stored in the memory unit 103.

The remote control signal transmitter 104 transmits a remote control signal, controlled by the controller 102, to the AV system 110. The remote control signal transmitter 104 may include an infrared ray transmitting circuit, which is installed in the existing remote control.

The AV system 110 is an image processing system, such as a home theater system including a DVD player and a television. Also, the AV system 110 can be remotely controlled and have an on-screen-display (OSD) function. The AV system 110 includes a remote control signal receiver 111, a controller 112, a memory unit 113, an on-screen-display (OSD) processor 114, a display unit 115, and a function executing unit 116.

The remote control signal receiver 111 receives a remote control signal transmitted from the remote control signal transmitter 104. In the case where the remote control signal transmitter 104 is an infrared ray transmitting circuit, the remote control signal receiver 111 is an infrared ray receiving circuit. The received remote control signal is transmitted to the controller 112.

The controller 112 checks whether a code corresponding to the received remote control signal is stored in the memory unit 113. The code information corresponding to remote control signals related to the functions of the AV system 110 is stored in the memory unit 113. If a code corresponding to the received remote control signal is not stored in the memory unit 113, the controller 112 ignores the received remote control signal.

However, if a code corresponding to the received remote control signal is stored in the memory unit 113, the controller 112 determines if the received remote control signal is related to the information regarding the major functions or the additional function display, based on the code read from the memory unit 113. When the received remote control signal is related to a major function, the controller 112 causes the function executing unit 116 to carry out the major function.

The function executing unit 116 is set in accordance with the functions of the AV system 110. For instance, if the remote control 110 requests the AV system 110 to be turned off, the controller 112 causes the function executing unit 116 to turn off power to devices included in the AV system 110. The function executing unit 116 may be composed of a plurality of devices that are categorized by the functions of the AV system 110. In this case, the function of turning off power to the AV system 110 is considered as being a major function of the AV system 110.

If the received remote control signal is a signal for requesting the additional functions display, the controller 112 reads the information for the additional functions from the memory unit 113, and provides the read information to the OSD processor 114.

Then, the OSD processor 114 generates OSD data corresponding to the additional function information in order to display the additional function information. The OSD processor 114 is the same as an OSD processing circuit included in the existing AV system. The OSD data is sent to the display unit 115. The display unit 115 displays the OSD data. FIG. 2B shows an example of a display screen on which information for additional functions is displayed.

When a user looks at the display screen and presses a directional key on the button unit 101, the controller 112 regards it as position information for selecting a desired additional function from the additional functions that are currently displayed on the display screen.

The controller 112 displays the information on the additional function, which is designated based on the received directional key information, to be differentiated from the information on the other additional functions. For instance, as shown in FIG. 2B, the controller 112 causes the selected additional function information to be darker or lighter than the other additional function information.

The information regarding additional functions stored in the memory unit 113 can be updated whenever the functions of the AV system 110 are updated or a new function is added to the AV system 110. Accordingly, the remote control 100 does not need to set new buttons in the button unit 101 even if the functions of the AV system 110 are updated or have a new function.

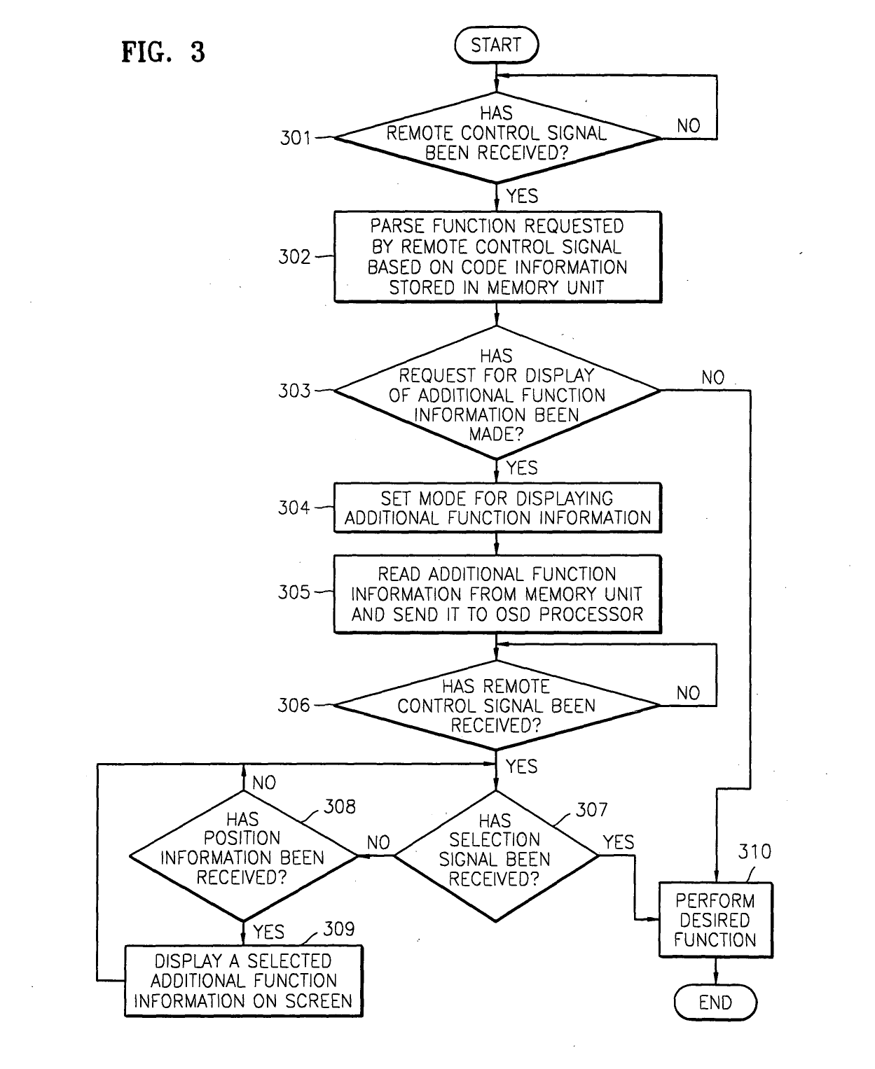

FIG. 3 is a flowchart illustrating a method of controlling functions of an audio/video (AV) system using a remote control according to a preferred embodiment of the present invention.

First, the AV system 110 receives a remote control signal from the remote control 100 in 301. Then the controller 112 parses the function requested by the remote control signal, based on code information stored in the memory unit 113, in 302. In other words, the controller 112 parses the remote control signal in order to determine whether the function selected by the remote control 100 is one of the major functions, or a request for displaying the information regarding additional functions.

In 303, if it is determined that the request for displaying the additional function information is received, the controller 112 sets a mode for displaying the additional function information in 304.

Next, the controller 112 reads the additional function information stored in the memory unit 113, and provides the information to the OSD processor 114 in 305. Then, the OSD processor 114 provides OSD data corresponding to the additional function information to the display unit 115. The display unit 115 displays the OSD data on a display screen.

In 306, if it is determined that a remote control signal is received from the remote control 100 while the OSD data for the additional function information is displayed, the controller 112 checks whether the remote control signal is a selection signal in 307. The selection signal is generated using a selection button shown in FIG. 2A in order to designate a desired additional function.

If it is determined in 307 that the remote control signal is not the selection signal, the controller 112 checks whether the remote control signal is position information in 308. The position information is input using the directional keys located around the selection button as shown in FIG. 2A, and discloses the position of additional function information to be selected.

If it is determined in 308 that the received remote control signal is the position information, the selected additional function according to the position information is marked on a display screen as shown in FIG. 2B in 309, and then the method returns back to 307. As mentioned in FIG. 1, a brightness level of the additional function selected using the directional keys may be set differently from a brightness level of additional functions which are not selected. If it is determined in 308 that the received remote control signal is not related to the position information, the method returns back to 307.

If it is determined in 303 that the request for displaying the additional function information is not received, or in 307 that the received remote control signal is the selection signal, the controller 112 causes the function executing unit 116 to perform a selected function of the AV system 110 in 310.

As described above, in a system according to an embodiment of the present invention, function buttons which are frequently used are installed on a remote control, and information regarding the other functions, which are not frequently used, is displayed on a display screen of the system that is controlled by the remote control. Therefore, the number of buttons installed on the remote control can be minimized. Further, it is possible to control the operation of the system using the remote control without upgrading the remote control to include new function buttons, even if the function of the system is updated or a new function is added to the system. Also, when the number of buttons on the remote control is minimized, it is possible to minimize the time spent for a user to learn how to use the remote control.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus controlling functions of an image processing apparatus using a remote control, the apparatus comprising:
a remote control signal receiver receiving a remote control signal output from the remote control;
a memory unit storing major function information and additional function information of the image processing apparatus;
a controller causing the additional function information stored in the memory unit to be displayed and causing an additional function that is selected based on the displayed additional function information to be performed, in response to the remote control signal containing a request to display the additional function information; and
a display unit displaying the additional function information controlled by the controller.

2. The apparatus of claim 1, further comprising an on-screen-display (OSD) processor, controlled by the controller, generating OSD data corresponding to the additional function information, and outputting the OSD data to the display unit.

3. The apparatus of claim 2, wherein the OSD data is processed by an existing OSD processing circuit in the image processing apparatus.

4. The apparatus of claim 1, wherein in response to the controller receiving a selection signal corresponding to desired additional function information, the controller marks the desired additional function information selected among the displayed additional function information.

5. The apparatus of claim 4, wherein the controller marks the desired additional function information selected by making the desired information darker or lighter than unselected additional function information.

6. The apparatus of claim 4, wherein the controller marks the desired additional function information selected by making the desired information a different color than unselected additional function information.

7. The apparatus of claim 1, wherein the major function information and the additional function information stored in the memory unit are categorized by the frequency of use of the information.

8. The apparatus of claim 1, wherein the apparatus comprises an infrared ray receiving circuit.

9. The apparatus of claim 8, wherein the remote control comprises an infrared ray transmitting circuit.

10. The apparatus of claim 1, wherein the additional function information is modified without modifying the remote control.

11. The apparatus of claim 1, further comprising directional keys provided on the remote control, with which a user selects from the displayed additional function information.

12. The apparatus of claim 11, further comprising a selection button provided along with the directional keys.

13. A method of controlling the functions of an image processing apparatus using a remote control, the method comprising:
parsing a received remote control signal received from the remote control;
displaying information for available additional functions on the image processing apparatus if the remote control signal contains a request for displaying information of additional functions; and
performing a function of the image processing apparatus which corresponds to a selection signal in response to the selection signal being received from the remote control while the additional function information is displayed.

14. The method of claim 13, wherein the additional function information is displayed as OSD data.

15. The method of claim 13, wherein in response to receiving position information for selecting desired additional function information among the additional function information displayed, a position for the selected additional function information is marked on the displayed additional function information so that a user can perceive the selected additional function information.

16. The method of claim 15, wherein the selected additional function information is marked by making it darker or lighter than remaining displayed additional function information.

17. The method of claim 15, wherein the selected additional function information is marked by making it a different color than remaining displayed additional function information.

18. The method of claim 13, wherein the additional function information is determined based on the frequency of use of information in the image processing apparatus.

19. The method of claim 13, wherein the parsing of the received remote control signal comprises differentiating between major functions and the available additional functions.

20. An image processing system comprising:
a remote control;
a remote control signal receiver receiving a remote control signal output from the remote control;
a memory unit storing major function information and additional function information of the image processing system;
a controller controlling the additional function information stored in the memory unit to be displayed and controlling an additional function that is selected based on the displayed additional function information to be performed, in response to the remote control signal containing a request to display the additional function information; and
a display unit displaying the additional function information controlled by the controller.

21. An apparatus controlling functions of an image processing apparatus using a remote control, the apparatus comprising:
a controller differentiating between major functions and additional functions in response to receiving a signal from the remote control, and causing additional function information to be displayed, and causing an additional function that is selected based on the displayed additional function information to be performed, in response to the remote control signal containing a request to display the additional function information; and
a display unit displaying the additional function information controlled by the controller.
